(19) United States
(12) Patent Application Publication
(10) Pub. No.: US 2021/0245749 A1
(43) Pub. Date: Aug. 12, 2021

(54) VEHICLE ADAPTIVE CONTROL

(71) Applicant: Continental Automotive Systems, Inc., Auburn Hills, MI (US)

(72) Inventors: Dennis J. Ross, Rochester Hills, MI (US); Justin Audley Ruediger, Royal Oak, MI (US); Patrick Alan Crane, Lake Orion, MI (US)

(73) Assignee: Continental Automotive Systems, Inc., Auburn Hills, MI (US)

(21) Appl. No.: 16/789,085

(22) Filed: Feb. 12, 2020

(51) Int. Cl. B60W 30/165; B60W 30/16; B60W 50/00

(52) U.S. Cl. CPC B60W 30/165; B60W 30/162; B60W 50/0097; B60W 2420/42; B60W 2552/15; B60W 2554/802; B60W 2520/105; B60W 2720/10; B60W 2420/52

(57) ABSTRACT

A method of controlling a vehicle includes the steps of identifying a lead vehicle with at least one sensor on the vehicle, tracking the lead vehicle with the at least one sensor, and maintaining the vehicle at a predetermined following position from the lead vehicle based on a position of the lead vehicle and a terrain adjacent at least one of the vehicle or the lead vehicle.

### BACKGROUND

The present disclosure is related to controlling a vehicle position relative to another vehicle.

Vehicles include a greater number of autonomous features, such as features that are able to provide driving control with less driver intervention. One example includes autonomous parking where the vehicle is automatically steered into a parking spot. Additionally, systems provide adaptive cruise control that maintains a predetermined distance between a vehicle and a lead vehicle encountered on a road.

### SUMMARY

In one exemplary embodiment, a method of controlling a vehicle includes the steps of identifying a lead vehicle with at least one sensor on the vehicle, tracking the lead vehicle with the at least one sensor, and maintaining the vehicle at a predetermined following position from the lead vehicle based on a position of the lead vehicle and a terrain adjacent at least one of the vehicle or the lead vehicle.

In a further embodiment of any of the above, tracking the lead vehicle includes distinguishing the lead vehicle from at least one other vehicle.

In a further embodiment of any of the above, distinguishing the lead vehicle from the at least one other vehicle includes generating a predicted location of the lead vehicle and comparing the predicted location of the lead vehicle with a location of an unidentified vehicle.

In a further embodiment of any of the above, the unidentified vehicle is eliminated as the lead vehicle when the unidentified vehicle is not located within a predetermined range of the predicted location of the lead vehicle.

In a further embodiment of any of the above, the unidentified vehicle is identified as the lead vehicle when the unidentified vehicle is located within a predetermined range of the predicted location of the lead vehicle.

In a further embodiment of any of the above, the predicted location is based on a last know speed and direction of the first lead vehicle.

In a further embodiment of any of the above, includes delaying a change in speed of the vehicle based on a predetermined time from a last tracking of the lead vehicle.

In a further embodiment of any of the above, maintaining the vehicle at the predetermined following position includes monitoring a characteristic of the terrain adjacent at least one the vehicle and the lead vehicle and varying a speed of the vehicle based on the characteristic of terrain.

In a further embodiment of any of the above, monitoring the characteristic of the terrain includes monitoring at least one of a slope of the terrain or a surface property of the terrain.

In a further embodiment of any of the above, the terrain adjacent the vehicle and the lead vehicle includes a terrain between the vehicle and the lead vehicle.

In a further embodiment of any of the above, maintaining the vehicle at the predetermined following position includes delaying movement of the vehicle until the first lead vehicle traversed a predetermined piece of terrain.

In a further embodiment of any of the above, the at least one sensor includes at least one camera.

In a further embodiment of any of the above, the at least one sensor includes at least one radar sensor.

In a further embodiment of any of the above, the at least one sensor includes at least one lidar sensor.

In a further embodiment of any of the above, generating a virtual bumper for the vehicle with at least one parking sensor and varying a speed of the vehicle if an object appears within an area defined by the virtual bumper.

In another exemplary embodiment, a control system for a vehicle includes at least one sensor. A controller associated with the at least one sensor is configured to perform the following steps identifying a first lead vehicle with a least one sensor on the vehicle, tracking the first lead vehicle with the at least one sensor, and maintaining the vehicle at a predetermined following distance from the first lead vehicle based on a position of the first lead vehicle and a terrain adjacent the vehicle and the first lead vehicle.

In a further embodiment of any of the above, tracking the lead vehicle includes distinguishing the first lead vehicle from at least one second vehicle by generating a predicted location of the first vehicle and comparing the predicted location of the first vehicle with the at least one second vehicle.

In a further embodiment of any of the above, maintaining the vehicle at the predetermined following position includes monitoring a characteristic of the terrain adjacent at least one the vehicle and the lead vehicle and varying a speed of the vehicle based on the characteristic of terrain.

In a further embodiment of any of the above, monitoring the characteristic of the terrain includes monitoring at least one of a slope of the terrain or a surface property of the terrain.

In a further embodiment of any of the above, the at least one sensor includes at least one of a camera, radar, or lidar.

### BRIEF DESCRIPTION OF THE DRAWINGS

FIG. 1 illustrates a schematic view of a vehicle having a vehicle control system.

FIG. 2 illustrates the vehicle of FIG. 1 in an example following situation.

FIG. 3 illustrates the vehicle of FIG. 1 in another example following situation.

FIG. 4 illustrates a method of operating the vehicle control system of FIG. 1.

### DETAILED DESCRIPTION

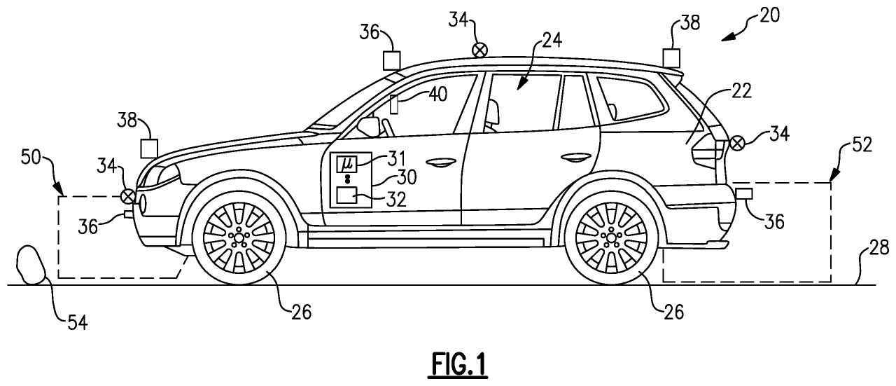

FIGS. 1 illustrates an example vehicle 20 having a chassis 22 at least partially defining a passenger compartment 24 and supported on a plurality of wheels 26 for traveling along terrain 28. The vehicle 20 also includes a vehicle control system 30 having a microprocessor 31 in electrical communication with a computer readable medium 32 for performing the operations outlined in further detail below.

The vehicle control system 30 is in electrical communication with a plurality of sensors throughout the vehicle 20, such as at least one camera 34, radar system 36, and lidar system 38. The at least one camera 34 can include a camera 34 located on the front, roof, and/or rear of the vehicle 20. The at least one radar system 36 and/or lidar system 38 can also be located on the front or rear of the vehicle 20. The radar system 36 can be short range, such as those used for parking sensors on a front or a rear of the vehicle 20, or long range radar that can extend multiple vehicle lengths from the vehicle 20.

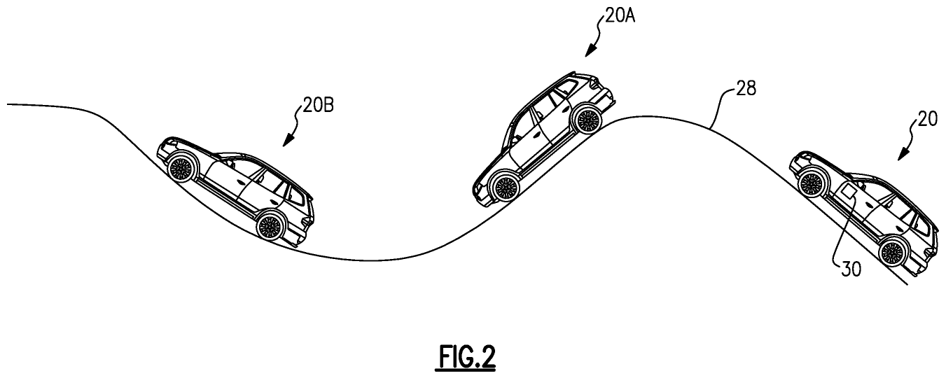

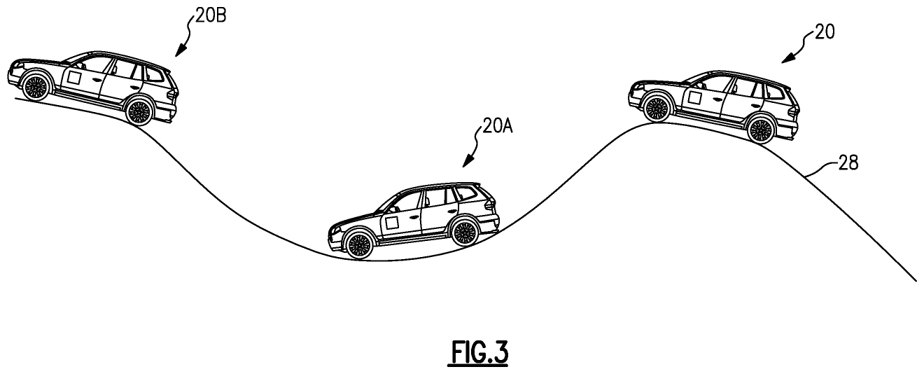

As shown in FIGS. 2 and 3, the vehicle 20 can travel in a group with other vehicles, such as with vehicles 20A and 20B, over terrain 28. The terrain 28 can have varying slope, such as upward or downward slopes, and surface characteristics, such as rocky, snowy, and/or muddy surfaces. When the vehicle 20 is traveling along the terrain 28, a vehicle operator can select to have the vehicle 20 follow the vehicle 20A immediately ahead of the vehicle 20 as a lead vehicle 20A.

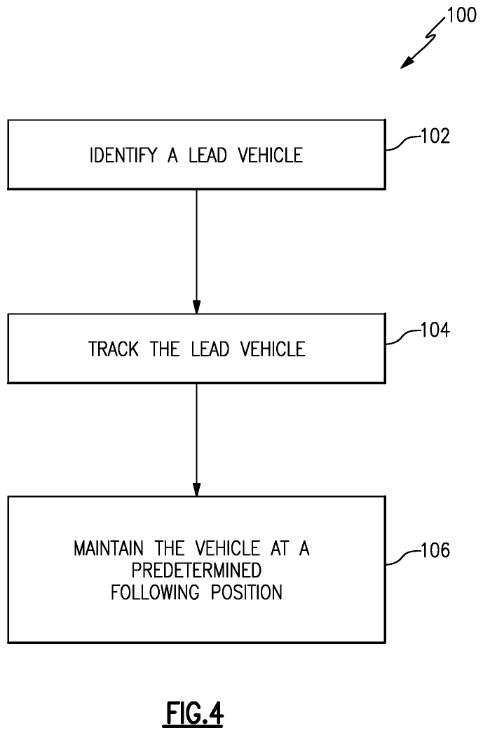

FIG. 4 illustrates a method 100 of operating the vehicle 20 with the control system 30 to follow the lead vehicle 20A. The control system 30 utilizes the at least one camera 34, radar system 36, or lidar system 38 to identify the lead vehicle 20A in front of the vehicle 20 (Step 102). For example, the at least one camera 34 can be used to generate an image on a screen 40, such as a touch screen, in the vehicle 20 showing the lead vehicle 20A. A vehicle occupant can then select the lead vehicle 20A on the screen 40 through interacting with the touch screen. The control system 30 can then identify the vehicle 20A through at least one of the sensors 34, 36, or 38. Alternatively, the control system 30 can identify possible lead vehicles on the screen 40 and allow the vehicle occupant to confirm the choice of lead vehicle. The vehicle occupant may be the operator of the vehicle 20 or a passenger in the vehicle 20.

Once the vehicle 20A has been identified as the lead vehicle, the control system 30 tracks the vehicle 20A using at least one of the sensors 34, 36, or 38 (Step 104). When the vehicle 20A is being tracked, the control system 30 can illustrate the vehicle 20A on the screen 40 with a marking, bracket, or other identifying insignia. This allows the vehicle occupant to have a visual confirmation of the lead vehicle 20A and also provide an additional identification of the location of the vehicle 20A during low visibility conditions, such as those caused by snow, dust, or darkness.

When the control system 30 is tracking the lead vehicle 20A, the control system 30 may need to distinguish between the lead vehicle 20A from other vehicles, such as the vehicle 20B. Furthermore, the lead vehicle 20A, may repeatedly move into and out of sight of the vehicle 20 and its sensors 34, 36, or 38 such that the lead vehicle 20A will need to be reacquired by the control system 30 for tracking. For example, when the vehicle 20A crests the hill on the terrain 28, as shown in FIG. 2, and moves into the valley as shown in FIG. 3, the vehicle 20A may be out of sight of the sensors 34, 36, and 38 such that a location of the vehicle 20A is no longer known to the control system 30 and needs to be reacquired. Similarly, the vehicle 20A may be out of sight of the sensors 34, 36, and 38 on the vehicle 20 by moving in either a left or right direction such that the location of the vehicle 20A is no longer known and needs to be reacquired by the control system 30.

When the lead vehicle 20A is being reacquired, the control system 30 can alert the vehicle occupant of the need to reacquire the lead vehicle 20A. Additionally, the vehicle occupant may assist the control system 30 in reacquiring the lead vehicle 20A through selecting the lead vehicle 20A on the touch interface on the screen 40 to allow the control system 30 to be able to track the lead vehicle 20A again.

Alternatively, the control system 30 can distinguish the lead vehicle 20A from other vehicles 20B without assistance from the vehicle occupant. For example, to distinguish between the first lead vehicle 20A and another vehicle, the control system 30 can generate a predicted location of the lead vehicle 20A and compare the predicted location of the lead vehicle 20A with vehicles identified by at least one the sensors 34, 36, or 38. The predicted location of the lead vehicle 20A can be generated based on at least one of a last known location, speed, and direction of the lead vehicle 20A. When a location of other vehicles, such as the vehicle 20B, are detected by the control system 30, the location is then compared to the predicted location of the lead vehicle 20A.

In this example, the vehicle 20B can be eliminated as a possible lead vehicle because it is not within a predetermined range of the predicted location of the lead vehicle. The predetermined range applied to the predicted location can depend on at least one of a time elapsed since the lead vehicle was last tracked, a last know speed of the lead vehicle, and/or a condition of the terrain 28. If the lead vehicle 20A is not found, the control system 30 continues to compare other vehicles to the predicated location and the predetermined range for the lead vehicle 20A until the control system 30 has reacquired the lead vehicle 20A. Additionally, when the control system 30 is attempting to reacquire the lead vehicle 20A, the control system 30 can delay a change in speed of the vehicle 20 for a predetermined time. Alternatively, the control system 30 can reduce a speed of the vehicle 20 until the lead vehicle 20A is reacquired by the control system 30.

The control system 30 can also maintain the vehicle 20 at a predetermined following position from the lead vehicle 20A (Step 106). The following position of the vehicle 20 relative to the lead vehicle 20A can be based on a number of factors. For example, the control system 30 can monitor the terrain 28 between the vehicle 20 and the lead vehicle 20A and vary a speed of the vehicle 20 based on the terrain 28. The terrain 28 between and/or adjacent the vehicle 20 and lead vehicle 20A is evaluated by the control system 30 through at least one of sensors 34, 36, or 38. Properties of the terrain 28, such as slope and surface characteristics, can be considered by the control system 30 to determine the following location of the vehicle 20 relative to the lead vehicle 20A.

Additionally, the control system 30 can delay movement of the vehicle 20 until the lead vehicle 20A has cleared a specific portion of the terrain 28. For example, the control system 30 may delay the vehicle 20 from advancing along the terrain 28 until the lead vehicle 20A passes a crest of an upward slope or a base of a downward slope of the terrain 28. Alternatively, the control system 30 can delay movement of the vehicle 20 until the lead vehicle 20A has cleared a portion of the terrain 28 with a predetermined surface property, such as obstacles 54 of a predetermined size, snow, or ice.

Furthermore, as illustrated in FIG. 1, the control system 30 can generate a virtual bumper 50 surrounding a front of the vehicle 20 and a virtual bumper 52 surrounding a rear of the vehicle 20. The virtual bumpers 50, 52 can be created in connection with the sensors of the radar system 36 adjacent the bumpers on the front and drear of the vehicle 20, such as the parking sensors. When the control system 30 identifies the obstacle 54 entering a space defined by one of the virtual bumpers 50, 52, the control system 30 can stop the vehicle 20 or change a speed of the vehicle 20 if a size of the obstacle 54 exceeds a predetermined size of obstacle that the vehicle 20 is capable of traversing.

Although the different non-limiting examples are illustrated as having specific components, the examples of this disclosure are not limited to those particular combinations. It is possible to use some of the components or features from any of the non-limiting examples in combination with features or components from any of the other non-limiting examples.

It should be understood that like reference numerals identify corresponding or similar elements throughout the several drawings. It should also be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claim should be studied to determine the true scope and content of this disclosure.

What is claimed is:

1. A method of controlling a vehicle, comprising the steps of:
identifying a lead vehicle with at least one sensor on the vehicle;
tracking the lead vehicle with the at least one sensor; and
maintaining the vehicle at a predetermined following position from the lead vehicle based on a position of the lead vehicle and a terrain adjacent at least one of the vehicle or the lead vehicle.

2. The method of claim 1, wherein tracking the lead vehicle includes distinguishing the lead vehicle from at least one other vehicle.

3. The method of claim 2, wherein distinguishing the lead vehicle from the at least one other vehicle includes generating a predicted location of the lead vehicle and comparing the predicted location of the lead vehicle with a location of an unidentified vehicle.

4. The method of claim 3, wherein the unidentified vehicle is eliminated as the lead vehicle when the unidentified vehicle is not located within a predetermined range of the predicted location of the lead vehicle.

5. The method of claim 4, wherein the unidentified vehicle is identified as the lead vehicle when the unidentified vehicle is located within a predetermined range of the predicted location of the lead vehicle.

6. The method of claim 3, wherein the predicted location is based on a last know speed and direction of the first lead vehicle.

7. The method of claim 3, including delaying a change in speed of the vehicle based on a predetermined time from a last tracking of the lead vehicle.

8. The method of claim 1, wherein maintaining the vehicle at the predetermined following position includes monitoring a characteristic of the terrain adjacent at least one the vehicle and the lead vehicle and varying a speed of the vehicle based on the characteristic of terrain.

9. The method of claim 8, wherein monitoring the characteristic of the terrain includes monitoring at least one of a slope of the terrain or a surface property of the terrain.

10. The method of claim 8, wherein the terrain adjacent the vehicle and the lead vehicle includes a terrain between the vehicle and the lead vehicle.

11. The method of claim 1, wherein maintaining the vehicle at the predetermined following position includes delaying movement of the vehicle until the first lead vehicle traversed a predetermined piece of terrain.

12. The method of claim 1, wherein the at least one sensor includes at least one camera.

13. The method of claim 12, wherein the at least one sensor includes at least one radar sensor.

14. The method of claim 13, wherein the at least one sensor includes at least one lidar sensor.

15. The method of claim 1, including generating a virtual bumper for the vehicle with at least one parking sensor and varying a speed of the vehicle if an object appears within an area defined by the virtual bumper.

16. A control system for a vehicle comprising:
at least one sensor;
a controller associated with the at least one sensor and configured to perform the following steps:
identifying a first lead vehicle with a least one sensor on the vehicle;
tracking the first lead vehicle with the at least one sensor; and
maintaining the vehicle at a predetermined following distance from the first lead vehicle based on a position of the first lead vehicle and a terrain adjacent the vehicle and the first lead vehicle.

17. The system of claim 16, wherein tracking the lead vehicle includes distinguishing the first lead vehicle from at least one second vehicle by generating a predicted location of the first vehicle and comparing the predicted location of the first vehicle with the at least one second vehicle.

18. The system of claim 16, wherein maintaining the vehicle at the predetermined following position includes monitoring a characteristic of the terrain adjacent at least one the vehicle and the lead vehicle and varying a speed of the vehicle based on the characteristic of terrain.

19. The system of claim 16, wherein monitoring the characteristic of the terrain includes monitoring at least one of a slope of the terrain or a surface property of the terrain.

20. The system of claim 16, wherein the at least one sensor includes at least one of a camera, radar, or lidar.
